(19) United States
(12) Patent Application Publication
(10) Pub. No.: US 2006/0081094 A1
(43) Pub. Date: Apr. 20, 2006

(54) Plumbing tool set

(76) Inventors: John E. Ludwig, Taylors, SC (US); Mac P. McElrath, Taylors, SC (US)

Correspondence Address: John Hardaway;NEXSEN PRUET LLC, P.O. Box 10107, Greenville, SC, 29603, US

(21) Appl. No.: 10/969,146

(22) Filed: Oct. 20, 2004

(51) Int. Cl. B25B 13/00; B25B 13/48

(52) U.S. Cl. 81/124.2; 81/176.15

(57) ABSTRACT

A plumbers tool set packaged in a container having a transparent plastic cover includes a hex nut socket wrench, a tubular flange nut socket wrench, a driver rod and a turning rod. The tool set permits a plumber to quickly install and remove the faucet unit and spray nozzle holder associated with washbasins and kitchen sinks.

### BACKGROUND OF THE INVENTION

The typical kitchen sink or wash basin is provided openings for mounting a faucet unit which includes a pair of downwardly extending externally threaded hot and cold water nipples and an externally threaded nipple to which a spray house is attached. The sink or basin may also include an opening for attachment of a hollow spray nozzle holder which has an externally threaded nipple through which the spray hose loosely extends. Flanged nuts are threaded on the hot and cold water nipples and on the spray nozzle holder nipple, thus securing the faucet unit and the spray nozzle holder to the sink or basin. Hot and cold water lines have nuts rotatably secured to their ends which threadedly engage the corresponding hot and cold water nipples of the faucet unit. A spray nozzle is connected to one end of a long hose which passes through the hollow nipple of the spray nozzle holder. The other end of the hose is connected to the spray hose attachment nipple by a nut rotatably mounted on that end. The beforementioned connections are behind the basin of the sink and its drainpipe. Hot and cold water shut off valves are typically mounted on a vertical counter wall behind the sink. The confined work space between the sink and the adjacent vertical wall and the nature of the connections make it difficult and time consuming to install or remove the faucet unit and/or spray nozzle holder. A conventional socket wrench cannot be used to remove the nuts attaching the hot and cold water lines because the nuts are secured to their respective hoses. The limited space makes use of an end wrench difficult or impossible. A totally different tool is needed to remove the flanged nuts securing the threaded nipples of the faucet unit and the spray nozzle holder. A set of special, but inexpensive, hand tools are needed to assist the plumber in installing and removing faucet units and spray nozzle holders.

### SUMMARY OF THE INVENTION

A set of plumber's hand tools are provided for quickly installing and removing faucet units and spray nozzle holders. The tool set includes a hex nut socket wrench for tightening or loosening the hex nuts securing the hot and cold water lines to threaded nipples on the faucet unit and a tubular flange nut socket wrench for installing and removing the flanged nuts used to secure the faucet unit and spray nozzle holder to a sink or a counter. Both socket wrenches are operated by the same driver rod, which includes a torque transmitting head, which releasably fits in a complimentary cavity or tool socket formed in each of the socket wrenches.

### BRIEF DESCRIPTION OF THE DRAWINGS

The invention is illustrated in the accompanying drawings, in which:

FIG. 1 shows the plumber's set of hand tools encased in a package having a transparent cover;

FIG. 2 is a top view of a hex nut socket wrench;

FIG. 3 is a bottom view of the hex nut socket wrench shown in FIG. 2;

FIG. 4 is a section taken on the line 4-4 in FIG. 3;

FIG. 5 is a side view of a tubular flange nut socket wrench with parts broken away for illustration purposes;

FIG. 6 is a side view of a driver rod;

FIG. 7 is side view of a turning rod;

FIG. 8 is a side view showing a faucet unit and a spray nozzle holder installed in a sink;

FIG. 9 is a side view showing the hex nut socket wrench applied to a hex nut securing a water line to a nipple of the faucet unit; and with parts broken away for illustration purposes; and

FIG. 10 is a side view showing the tubular flange nut socket wrench applied to a flange nut on a threaded nipple of the faucet unit with parts broken away for illustration purposes.

### DETAILED DESCRIPTION OF THE INVENTION

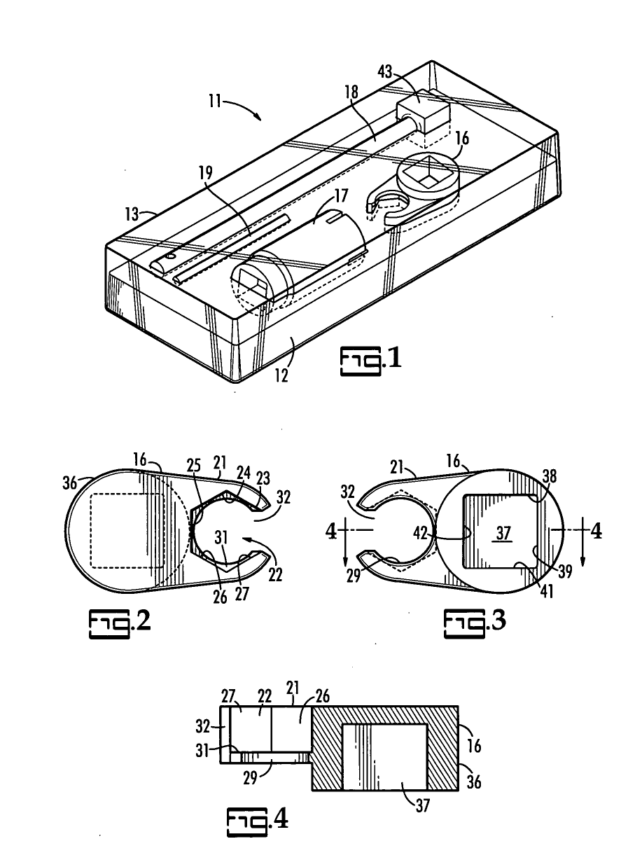

FIG. 1 shows a plumber's tool set package 11 in a container 12 having a transparent plastic top or cover 13. The individual components of the tool set are nested in recesses shaped to receive them. The tool set includes a hex nut socket wrench 16, a tubular flange nut socket wrench 17, an elongated driver rod 18 and a turning rod 19. The package 11 facilitates merchandising display of the tool set and, after purchase, the packaged set can be carried in the plumber's tool chest.

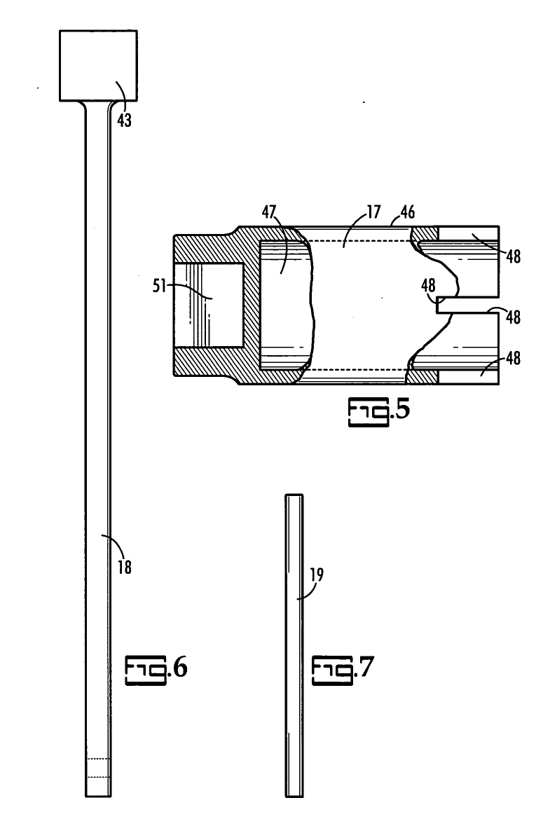

As shown in FIGS. 2, 3 and 4, the hex nut socket wrench 16 includes a first segment 21 having a wall structure forming a hex nut socket 22 defined by five inward facing planar surfaces 23, 24, 25, 26, 27 which are designed to engage a predetermined size hex nut so that it can be installed or removed from a threaded complementary threaded part. An annular shaped opening 29 is formed in the floor or bottom of the socket 22 thereby forming a shoulder 31 which abuts a hex nut during use of the socket wrench 16. A side opening 32 is formed in the wall structure which is large enough to permit passage of a water hose laterally into the socket 22. The hex nut socket wrench 16 includes a second segment 36 which is integrally formed with the first segment 21. The second segment 36 includes downwardly open square shaped tool socket 37 having a box shape with four sides 38, 39, 41, 42. The tool socket 37 is adapted to mate with the square shaped head 43 of the elongated driver rod 18, shown in FIG. 6.

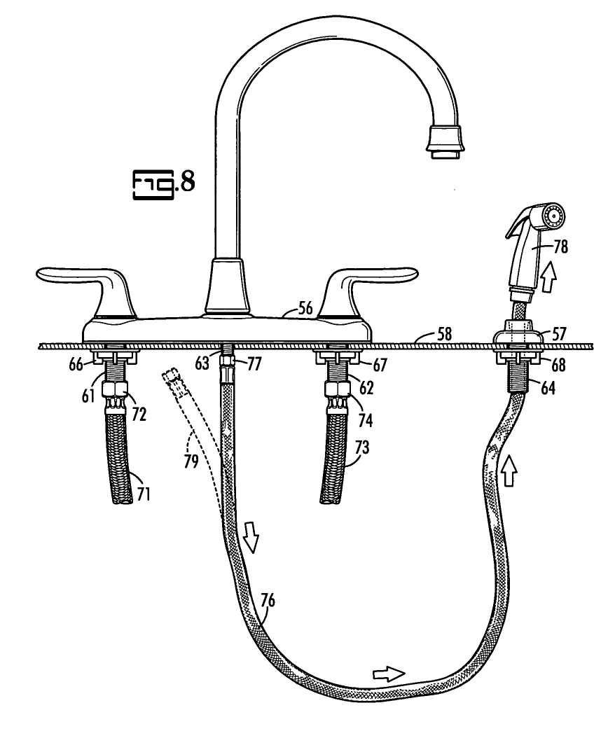

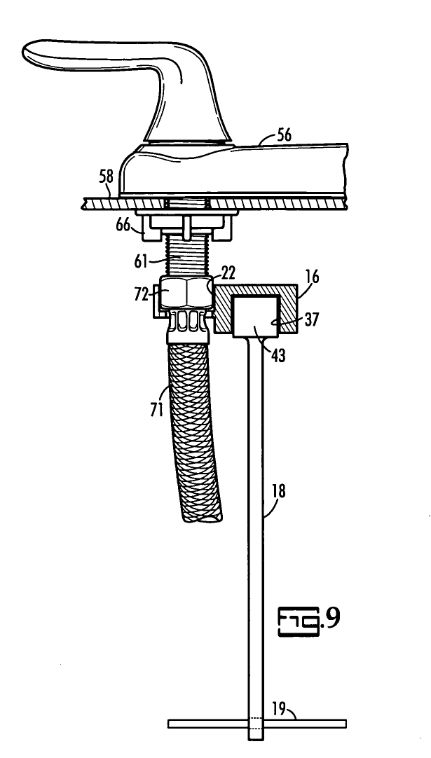

The tubular flange nut wrench 17 shown in FIG. 5 includes a cylinder wall 46 defining a cylindrical interior cavity 47, the open end of which includes four circumferentially spaced notches 48 for mating with the four flanges of a flange nut. The other end of the tubular flange nut wrench 17 includes a square shaped tool socket 51 which is adapted to receive the square shaped head 43 of the driver rod 18.

FIG. 8 shows a faucet unit 56 and a spray hose holder 57 installed in a kitchen sink 58. The faucet unit 56 has a threaded hot water receiving nipple 61, a threaded cold water receiving nipple 62 and a threaded spray nozzle hose attachment nipple 63 extending downwardly through openings in the sink 58. The spray nozzle holder 57 has a threaded nipple 64 extending downwardly through an opening in the sink 58. Flange nuts 66, 67, 68, each having four flanges, are threaded onto the nipples 61, 62, 64, thus securing the faucet unit 56 and the spray hose holder 57 to the sink 58. A flexible hot water line 71 is secured to the nipple 61 by a hex nut 72 rotatably connected to the end of the hot water line 71 and a flexible cold water line 73 is secured to the nipple 62 by a hex nut 74 rotatably secured to the end of the cold water line 73. A flexible spray nozzle hose 76 has one of its ends connected to the nipple 63 by a hex nut 77 rotatably connected to its one end. The spray nozzle hose 76 passes upwardly through the hollow nipple 64 and has its distal end connected to a spray nozzle 78. The nut 77 and the hose 76 are sufficiently small to permit their passage through the hollow spray nozzle holder 57 and its hollow nipple 64. Thus the spray nozzle hose 76 will be removed when the tubular flange nut wrench 17 is used to install or remove the spray nozzle holder 57. Broken lines 79 show the hose 76 removed from the nipple 63.

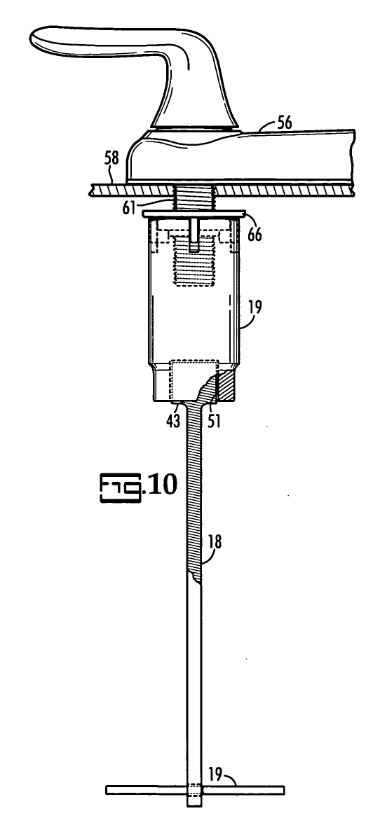

When installing or removing the hot water line 71, the hex nut socket wrench 16 is placed in the position shown in FIG. 9, which shows the hex nut socket 22 engaging the hex nut 72. The head 43 of driver rod 18 engages the tool socket 37 and upon rotating the driver rod 18 using the turning rod 19 the nut can be selectively installed on or removed from the nipple 61. In a like manner the hex nut socket wrench 16 can be used to install and remove the cold water line 73 from the nipple 62.

When the water line 71 is disconnected from the nipple 61, the tubular flange nut socket wrench 17 may be used, as shown in FIG. 10, to install or remove the flange nut 66 from the nipple 61. The necessary torque is applied by inserting the head of the driver rod 18 into the tool socket 51 and by rotating the driver rod 18 using the turning rod 19. In a similar manner the tubular flange nut socket wrench 17 can be used to install or remove the flange nuts 67, 68.

The hex nut socket wrench 16 and the tubular flange nut socket wrench 19 are designed to install and remove water hose nuts and flange nuts associated with faucet units and spray nozzle holders commonly mounted on household sinks, wash basins or counters. The space available behind sinks and wash basins is usually very limited because of the closeness of an adjacent vertical wall. The wrenches of the herein described tool set greatly facilitate the plumber's work—making the work faster and easier and saving the homeowner money.

1. A plumbers tool set package comprising:
a hex nut socket wrench having
a first segment including walls defining a hex nut socket extending downwardly from its top, a side opening in said socket and a bottom opening in said socket, said openings being sufficiently wide to permit a water conduit for a household sink to pass laterally through said side opening and into said bottom opening, a shoulder on said walls at the bottom of said socket adjacent said bottom opening, said shoulder preventing a hex nut mating with said hex nut socket from passing through said bottom opening,
a second segment rigidly secured to and disposed at one lateral side of said first segment including a downwardly open square shaped tool socket for receiving a square shaped head of a driver rod,
a tubular flange nut wrench including circumferentially spaced notches at one of its axially opposite ends for mating with the flanges of a flange nut and a square shaped tool socket at its other end for receiving said square shaped head of said driver rod,
an elongated driver rod having a square shaped head at one of its axially opposite ends adapted to drivingly engage said tool socket of a selected one of said wrenches and having a bore near its other end extending through said rod in transverse relation to the axis of said rod, and
a turning rod slideably insertable into said bore,
a container having recesses shaped to individually receive said first segment, said second segment, said nut wrench, said driver rod and said turning rod and a transparent plastic cover on said container.

2. (canceled)

3. (canceled)

4. (canceled)

5. (canceled)
